(19) United States
(12) Patent Application Publication
(10) Pub. No.: US 2023/0084022 A1
(43) Pub. Date: Mar. 16, 2023

(54) Wireless Golf Ball Charging Apparatus

(71) Applicant: Graff Golf LLC, Sandy Springs, GA (US)

(72) Inventors: Parker Feldmann, Reno, NV (US); Patrick Kelly, Mt. Airy, MD (US); Aaron Shapiro, Sandy Springs, GA (US); Michael Eberle, North Hampton, NH (US)

(73) Assignee: Graff Golf LLC, Sandy Springs, GA (US)

(21) Appl. No.: 17/472,595

(22) Filed: Sep. 11, 2021

(51) Int. Cl. H02J 50/12; A63B 37/00; H01M 10/42

(52) U.S. Cl. CPC H02J 50/12; A63B 37/005; H01M 10/425

(57) ABSTRACT

A method and system for charging an electronic golf ball are described herein. The system is made up of a charging apparatus and an electronic golf ball. The charging apparatus includes a holder for holding the electronic golf ball, a power transmitting apparatus mounted within the holder, the power transmitting apparatus encircling an area where the electronic golf ball is located when the electronic golf ball is to be charged, and a power supply electrically connected to the power transmitting device. The electronic golf ball includes an outer shell, a ball core covered by the outer shell, a power receiving apparatus within the ball core, wherein the power receiving apparatus receives power wirelessly from the power transmitting apparatus, a printed circuit board electrically connected to the power receiving apparatus, and a battery connected to the printed circuit board.

### BACKGROUND

### Related Applications

This patent application is a priority patent application.

### Technical Field

The system, apparatuses, and methods described herein generally relate to golf balls and, in particular, to intelligent golf balls with a rechargeable power source.

### Description of the Related Art

Golf as we know it today originated from a game played on the eastern coast of Scotland in the Kingdom of Fife during the 15th century. Players would hit a pebble around a natural course of sand dunes, rabbit runs, and tracks using a stick or primitive club. Wooden golf balls were the first man-made golf balls, invented in the 1400s. These original wooden golf balls were inefficient at best and likely made of hardwoods such as Beech or Boxroot. The first “real” golf ball was known as a “feathery” golf ball. Basically, the feathery was a leather sack filled with boiled goose feathers, then stitched up and painted. These golf balls were used from the 1400s until the 1840s. In 1848, Rev. Dr. Robert Adams began creating golf balls out of Gutta Percha “Gutty”. The Gutty golf ball was created from the dried sap of the Sapodilla tree. It had a rubber-like feel and was formed into ball shapes by heating it up and shaping it while hot. It was soon discovered that dinged balls traveled further than new, smooth balls, and golf ball manufacturers added dimples to the golf balls.

In the late 1800s, the inside of the golf ball changed to a solid rubber core, high tension rubber thread wrapped around the core, and a Gutta Percha cover. Various other cores were incorporated over the following years, with liquid, steel, lead, and glycerin used at various times. Today, two-piece solid Syrlin or Balata cover rubber cored balls are used. Recent rule changes (United States Golf Association (USGA)) for standard golf balls have allowed for balls with hollow steel spheres surrounded with rubber. With the improved designs in golf balls, the balls travel further. However, this means that the golf ball can travel further out of sight of the golfer and are more often lost than they were in the 1800s.

On average, most golfers lose four balls per round, adding a total of 20 minutes of play just searching for their ball. This means that tens of millions of golf balls are lost each year, leading to millions of dollars in extra cost to golfers. And the 20-minute delay in searching for lost golf balls slows down play on the course, leading to lost revenues for the country clubs.

There is a need for the technology of finding golf balls to catch up to the materials technology that has allowed for longer golf ball drives. The extreme number of lost golf balls creates a significant problem for golfers both in terms of cost and the inability of golfers to analyze their round. Golf balls can easily be lost in bushes and trees. They give the golfer no easy way to track golf ball movements and statistics.

There is a need for technology inside the balls to allow them to be found quickly through proximity and sound. However, each golf ball may undergo 15,000 G’s of force when the golf club hits the ball. Off of the club, the ball may spin at 9000 RPMs and travel at 180 miles per hour, so the technology must be hardened to the extreme physical forces. There is also a need for a software application to give a golfer helpful analytical data.

By placing electronics inside a golf ball, a method for providing power to the electronics needs to be solved. Batteries could be used, but have a limited shelf life, shorter than the typical life of a golf ball. The inventions described herein solve this problem with a wireless golf ball charging apparatus.

### BRIEF SUMMARY OF THE INVENTION

A system for charging an electronic golf ball is described herein. The system is made up of a charging apparatus and an electronic golf ball. The charging apparatus includes a holder for holding the electronic golf ball, a power transmitting apparatus mounted within the holder, the power transmitting apparatus encircling an area where the electronic golf ball is located when the electronic golf ball is to be charged, and a power supply electrically connected to the power transmitting device. The electronic golf ball includes an outer shell, a ball core covered by the outer shell, a power receiving apparatus within the ball core, wherein the power receiving apparatus receives power wirelessly from the power transmitting apparatus, a printed circuit board electrically connected to the power receiving apparatus, and a battery connected to the printed circuit board.

The printed circuit board may include a Qi chip. The power transmitting apparatus may include wires wound around the power transmitting apparatus to form a coil. The coil may be surrounded by EMI material. The EMI material could be a ferrite core. The EMI material may be surrounded by PET tape. The power receiving apparatus may include wires wound around the power receiving apparatus to form a coil. The EMI material may encircle the power receiving apparatus underneath the coil. The coil may be surrounded by PET tape.

A method for charging an electronic golf ball is also described here. The method includes (1) receiving power from a power supply, (2) delivering the power over a wire to a power transmitting apparatus, (3) wirelessly transmitting the power from the power transmitting apparatus through a golf ball outer shell and a golf ball core, (4) receiving the wirelessly transmitted power with a power receiving apparatus located within the golf ball core, (5) delivering the power from the power receiving apparatus to a power conditioning chip on a printed circuit board located in the electronic golf ball, (6) using the power from the power conditioning chip to recharge a battery located in the electronic golf ball; and (7) power the printed circuit board with the battery.

The power conditioning chip may be a Qi chip. The power conditioning chip may also directly provide the power to the printed circuit board. The power transmitting apparatus may include wires wound around the power transmitting apparatus to form a coil. The coil may be surrounded by EMI material. The EMI material could be a ferrite core. The EMI material may be surrounded by PET tape. The power receiving apparatus may include wires wound around the power receiving apparatus to form a coil. The EMI material may encircle the power receiving apparatus underneath the coil. The coil may be surrounded by PET tape.

An electronic golf ball apparatus is also described here. The electronic golf ball includes an outer shell, a ball core covered by the outer shell, a power receiving apparatus within the ball core, wherein the power receiving apparatus receives power wirelessly, a printed circuit board electrically connected to the power receiving apparatus, and a battery connected to the printed circuit board.

The power receiving apparatus may include wires wound around the power receiving apparatus to form a coil. EMI material may encircle the power receiving apparatus underneath the coil.

### BRIEF DESCRIPTION OF THE DRAWINGS

FIG. 1A is a perspective view of a golf ball in a golf ball charging apparatus.

FIG. 1B is a perspective view of the electrical components of the golf ball charging apparatus.

FIG. 1C is a top cutaway view of the electrical components of the golf ball charging apparatus.

FIG. 1D is a side cutaway view of the electrical components of the golf ball charging apparatus.

FIG. 2A is a perspective cutaway view of the golf ball showing the power receiving apparatus.

FIG. 2B is a cross-section top view of the golf ball showing the power receiving apparatus.

FIG. 2C is a perspective view of the assembled power receiving apparatus.

FIG. 2D is an exploded view of the power receiving apparatus.

FIG. 2E is a side cutaway view of the power receiving apparatus.

FIG. 3A is a perspective view of the assembled power transmitting apparatus.

FIG. 3B is an exploded view of the power transmitting apparatus.

FIG. 3C is a side cutaway view of the power transmitting apparatus.

### DETAILED DESCRIPTION

The present inventions describe several embodiments for charging the electronics in a golf ball, where the golf ball includes hardened electronics designed to handle the extreme forces the occur when the ball is hit by the club.

The wireless charging of a golf ball 110 and a charger 105 are described here, the design utilizing the science of magnetic inductance to transfer power from a generic Qi wireless charging transmitter. The charger takes power from a standard wall outlet to properly function.

The system of the charger 105 and the golf ball 110 employs a unique design and functionality of both the receiving (RX) and transmitting (TX) coils. The shape, the dimensions, the distance between coils, and the materials are all custom and unique.

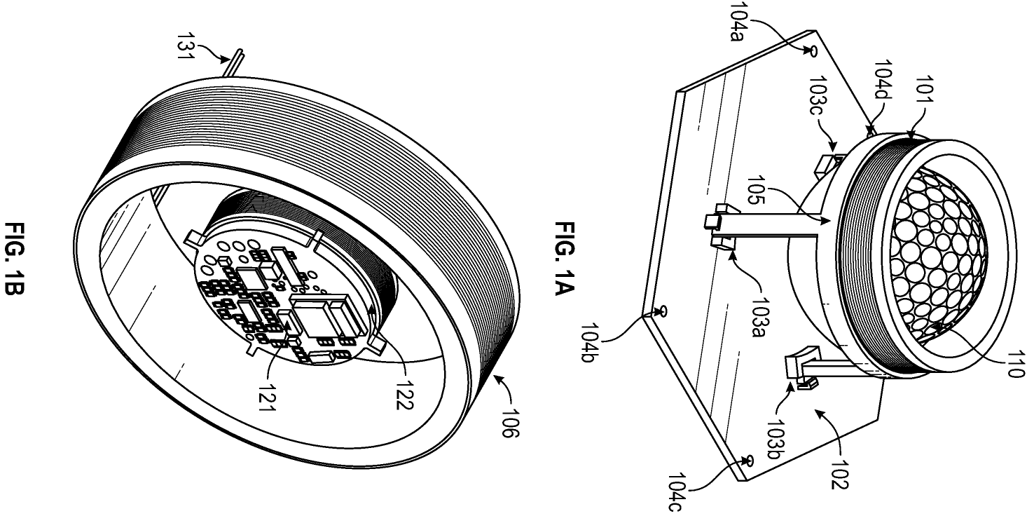

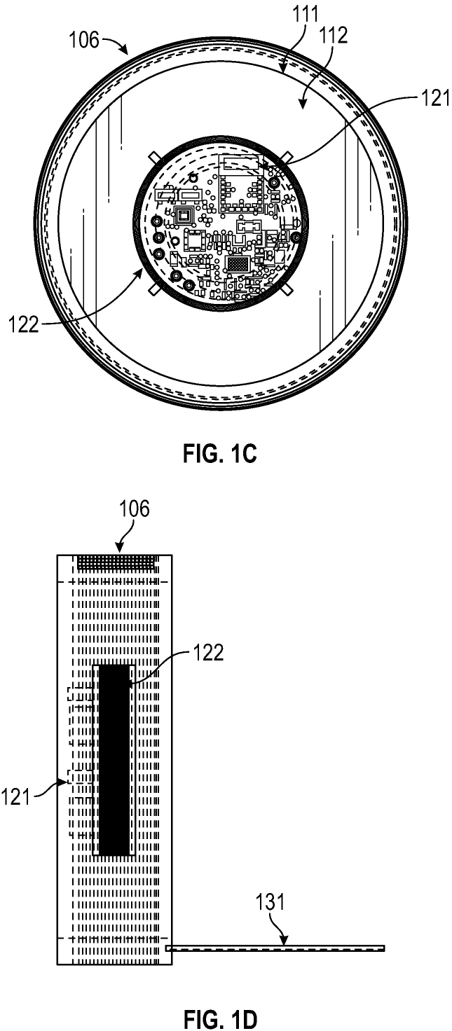

Looking first to FIG. 1A, a golf ball 110 is seen in the golf ball charger 105. The charger 105 has three legs in this embodiment, although any number of legs or holding apparatus could be used. The legs are attached to the base 102 at the base attachment points 103a-c. The base 102 could be a metal, wood, or plastic plate. In this embodiment, screw holes 104a-d are shown for attaching the holder 105 to another surface. In another embodiment, an egg carton-shaped holder 105 could be used to hold a plurality of golf balls 110 for charging at the same time. Other mechanical shapes of the holder 105 can be envisioned. The holder 105 contains one or more power transmitting apparatuses 101 for transmitting the power to the golf ball 110. The holder 105 has a power line 131 for supplying power to the power transmitting apparatus 101. In some embodiments, the power line 131 connects directly into 110-volt ac power, bringing the ac power directly to the power transmitting apparatus 101. In other embodiment, circuitry and transformers will rectify, condition and/or adjust the voltage and current from the ac power line before supplying power to the power transmitting apparatus 101. For instance, a normal 9W USB charger (5.2 V, 1.8 A) could be used to convert wall voltage to the wire 131. In this embodiment, the power transmitting apparatus 101 transmits 5 volts at 2 amps at a frequency of 100 kHz. This embodiment allows the power receiving apparatus 122 to receive about 1 volt at 2 amps at a frequency of 100 kHz. A Qi chip on the printed circuit board 121 then converts this energy to usable power for the printed circuit board 121

In some embodiments, the wire 131 may be connected to a printed circuit board on the charger 105 that can turn the power on or off on the power transmitting apparatus 101. In this embodiment, the printed circuit board may be in wireless communication, perhaps through Bluetooth, with the printer circuit board 121 in the golf ball 110 to receive instructions on whether to transmit power or not.

In some embodiments, a logo on the golf ball 110 lets the user know how to position the ball in the holder 105. For instance, when the logo is on the top of the ball 110 in the holder 105, the power receiving apparatus 122 is lined up with the power transmitting apparatus 106, allowing optimal power transmission. The depth of the holder 105 is set to align the power receiving apparatus 122 and the power transmitting apparatus 106 for optimal power transmission.

In FIG. 1B, the golf ball charging system is seen from an electrical viewpoint. The power line 131 is electrically and mechanically connected to the power transmitting apparatus 101, supplying power to the power transmitting apparatus 101.

The power is transmitted wirelessly to the power receiving apparatus 122. While this drawing shows a void between the power transmitting apparatus 101 and the power receiving apparatus 122, this void is a combination of air, golf ball shell 111, and golf ball core 112, as seen in FIG. 1C. The power receiving apparatus 122 is electrically connected to the printed circuit board 121. In some embodiments, the power receiving apparatus 122 is mechanically connected to the printed circuit board 121, perhaps connected to the top of the power receiving apparatus 122. In some embodiments, the assembled distance between the power transmitting apparatus 106 and the power receiving apparatus 122 is approximately 10.95 mm.

FIG. 1C shows a top view of the electrical view of the golf ball charging system. The power transmitting apparatus 101 is shown in the outer circle of FIG. 1C. The power transmitting apparatus 101 may or may not be physically touching the golf ball shell 111. In some embodiments, the golf ball 110 snuggly fits within the power transmitting apparatus 101. In other embodiments, there is an air gap between the golf ball 110 and the power transmitting apparatus 101. Inside of the golf ball shell 111 is the golf ball core 112. Inside of the golf ball core 112 is printed circuit board 121 and the power receiving apparatus 122. The power transmitting apparatus 101 transmits the power through the golf ball shell 111 and the golf ball core 112 to the power receiving apparatus 122.

FIG. 1D shows a side view of the electrical view of the golf ball charging system. Power arrives from the power line 131 and is directed to the power transmitting apparatus 106, from where it is electrically transmitted to the printed circuit board 121 and the battery 201. The printed circuit board 121 may have a QI Wireless Charger chip such as an Analog Devices LTC4124 to transform the power to allow for battery charging. The power transmitting apparatus 106 may comprise a number of electrical windings for transmitting the power. These windings are one or more wires wrapped around the power transmitting apparatus 106 as a coil for directing the wireless energy at the golf ball. The power receiving apparatus 122 also has a number of electrical windings for receiving the power. These windings are also one or more wires wrapped around the power receiving apparatus 122 as a coil for receiving the wireless energy from the holder 105.

### Golf Ball Design

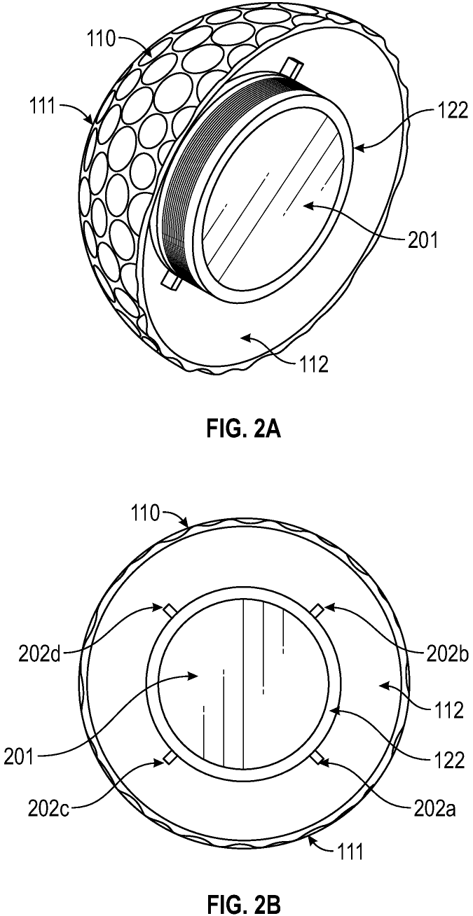

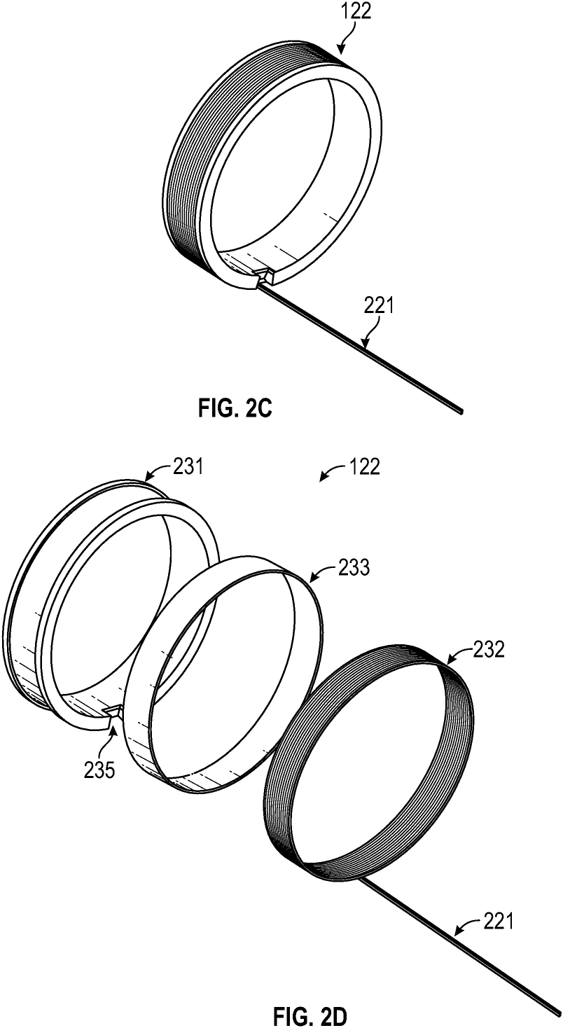

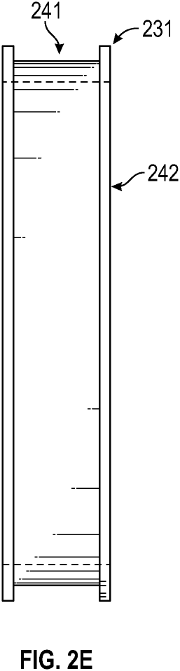

FIGS. 1A, 1C, 2A, and 2B show a golf ball 110 that includes a stiff hollow spherical core 112. The spherical core is surrounded by cover layer 111 that includes dimples or other surface features that are known in the art to improve flight characteristics. The cover layer 111 defines a cover thickness, which is about 4 mm, but may be any thickness between about 1 mm and about 6 mm, including all values and ranges in-between. The cover layer 111 with the surface dimple pattern is made of a polymer sold under the trade name SURLYN® (manufactured by DuPont). In another example, the cover layer 111 is made of an ionomer, urethane, balata, polybutadiene, other synthetic elastomers, or any other material suitable for a golf ball cover. The cover layer 111 also forms the golf ball diameter. In one embodiment, the golf ball diameter is approximately 42.67 mm (1.68 inches), but may be any diameter equal to, greater than, or less than 42.67 mm that is capable of play. For example, USGA legal golf balls are 1.68 inches (42.67 mm) or greater in diameter. For example, the golf ball diameter may be between about 40 mm and about 45 mm, including all values and ranges in between.

The spherical core 112 is a polymer matrix composite, metal matrix composite, or carbon matrix composite. The diameter of the spherical core 112 may be any diameter from about 10 mm (0.39 inches) to about 42 mm (1.60 inches), including all values and ranges in-between. At the center of the spherical core 112 is the printed circuit board 121, the battery 201, and the power receiving apparatus 122. These components are surrounded by a material, such as a polymer urethane visco-elastic material such as Sorbathane to absorb the impact of the golf club striking the golf ball. Sorbothane is described in a series of patents awarded to Dr. Maurice Hiles, including US Pat. 4,101,704, US Pat. 4,346,205, US Pat. 4,476,258, and US Pat. 4,808,469. In other embodiments, the Sorbothane could be replaced with Silicone, Neoprene, Norsorex, Rubber, Deflex, Gel-mec, Microsorb, Memory foam, Acoustic foam, or other similar material.

For more details of the golf ball construction, see US Pat. 10,864,410, “Bluetooth enabled ball analyzer and locator”, issued to Michael Eberle, Patrick Kelly, and Aaron Shapiro, said patent incorporated herein by reference.

### Golf Ball Circuitry

The printed circuit board 121 may include a BLE (Bluetooth Low Energy) Chip such as a Nordic nRF52832 or a Cyprus Semiconductor PSOC BLE chip; a QI Wireless Charger chip such as an Analog Devices LTC4124, an Accelerometer such as a 1428-1060-2-ND; one or two Magnetoresistive (MR) Sensors, such as a TI DRV5053CAQLPGM; a Battery 201 such as a PD521417 with a power control module and cables (the battery 201 could also be off-board); and a Buzzer, such as a 102-3746-1-ND. Each of these components may be soldered into the printed circuit board, in one embodiment. The BLE Chip includes memory, communications circuitry, and a microprocessor (BLE processor), as well as circuitry for interfacing with various sensors. In another embodiment, the BLE chip has the power control module, the wireless charger, the accelerometer, and the MR sensors integrated into a single integrated circuit, either as an ASIC or as a custom chip. Any combination or integration within an integrated circuit and separate components could be used without deviating from the inventions herein. In one embodiment, the components are surface mounted to the printed circuit board, and the board could also be encased in epoxy or silicon to increase its resistance to shock.

The BLE chip may be electrically connected to the accelerometer and the MR sensors. The BLE chip may include a processor, a Bluetooth PHY, radio and transponders, RAM and Flash RAM, analog and digital IO interfaces, and power management operations to operate in Bluetooth Lower Energy mode. A BLE antenna may also be electrically and mechanically attached to the BLE chip to transmit and receive the BLE signals. This allows the BLE chip to communicate wirelessly with other devices.

The battery 201 may be electrically connected to the BLE chip and supplies the appropriate power to the BLE chip. A QI wireless charging chip may also be electrically attached to the battery 201. An antenna (power receiving coil) 122 is also electrically and mechanically attached to the QI chip to receive power signals from a QI charger. Anytime that the antenna receives a usable voltage, the signal may be sent to the QI chip for conversion to the appropriate signal levels for recharging the battery. This power signal is then sent to the battery 201.

The Qi charge controlling component on the ball printed circuit board 121 may require a Boolean input (on, off) to start and stop the charge. This input to the Qi chip may come from can either be a separate self-contained circuit designed to monitor the battery 201 voltage level and send an automatic “on” or “off” signal to the Qi charging component according to the voltage levels it is reading. In a second embodiment, the signal may come directly from the processor which may be programmed to monitor the battery 201 voltage itself and send a signal to the Qi component accordingly. In this embodiment, an open INIT pin on the processor is configured to have an electrical connection from the processor to both enable pins located on the Qi charging controller component. The firmware for the processor may contain a maximum battery voltage level and send an “on” or “off” signal to the Qi charging component on the ball printed circuit board 121 against the max voltage limit. If the voltage of the battery 121 is below the max limit, indicating the battery is not 100% charged, the pin will stay “on”. If the ball 110 is placed into a charger 105 and the coils make a connection, the charge will then begin. Once the voltage reaches the maximum limit set within the processor, the component will go low, turning off the “on” signal which will tell the Qi charge component within the ball 110 to send (wirelessly, perhaps through Bluetooth) a “stop” or “off” signal to the transmitting coil within the ball charger 105. A printed circuit board on the charger 105 may receive this signal and stop sending power to the ball 110.

Looking to FIG. 2A, a perspective cutaway view of the golf ball 110 is shown. At the center of the golf ball 110 is a battery 201. The battery 201 is surrounded by the power receiving apparatus 122. The golf ball core 112 fills the area between the power receiving apparatus 122 and the outer shell 111 of the golf ball 110.

FIG. 2B shows a cutaway view of the golf ball 110. The outer shell 111 surrounds the entire assembly. Inside of the shell 111 is the ball core 112. The ball core surrounds the power receiving apparatus 122. Inside of the power receiving apparatus is the battery 201. Four tabs 202a-d from the printed circuit board 121 are also seen in FIG. 2B. The tabs 202a-d are used to locate the entire assembly during the molding process. This allows the printed circuit board 121 to be molded in a controlled way to ensure the assembly is properly centered in the ball 110. In some embodiments, other methods may be used to center and align the printed circuit board 121 in the center of the ball 110. In some embodiments, the distance between the outer edge of the shell 111 and the outer edge of the power receiving apparatus 122 is 8.64 mm.

FIG. 2C shows a perspective view of the assembled power receiving apparatus 122, including a 30 mm wire 221 to deliver the received power to the printed circuit board 121. Note that the length of the wire 221 can be changed without deviating from the inventions disclosed herein.

FIG. 2D shows an exploded view of the power receiving apparatus 122. The power receiving apparatus 122 starts with a bobbin 231 surrounded by EMI material 233, the coil 232, and PET tape (in some embodiments) .

The bobbin 231 could be made of ABS, other plastics, cardboard, wood, or other materials. In some embodiments, the bobbin 231 is injection molded, in others, it is milled to shape, and in still other embodiments, the bobbin 231 is 3D printed, or any combination thereof.

In some embodiments, the bobbin 231 is made of EMI materials. In other embodiments, the outer ring of the bobbin 231 is covered with an EMI material 233 such as copper and aluminum foils, metalized fabrics, conductive elastomers, conductive foams, metals, nickels, carbons, ceramics, cement, conductive polymers, and tapes/transfer adhesives. In some embodiments, the EMI material 233 is a ferrite core. The ferrite core 233 could be made up of a 0.05 mm thick strip of rubber (or silicon rubber), ferrite powder, and PET film, perhaps 4.00 mm wide and 85.00 mm long that is wrapped around the bobbin 231 with an overlap. The ferrite core 233 could be held to the bobbin 231 with an adhesive.

The EMI material 233 is surrounded (encircled) by the windings of the coil 232. The coil 232 could be made of copper wire, aluminum wire, carbon fiber wire, etc, with an insulation, such as varnish surrounding the wire. Any type of winding technique could be used, such as wild winding, helical winding, orthocyclic winding, etc. In one embodiment, the coil 232 is a single layer of 19 to 20 wraps of 32 AWG copper enameled magnet wire.

The windings 232 could be covered with a PET (polyethylene terephthalate) tape. The PET Tape could be made with polyester and could have an acrylic, silicone, and rubber adhesive to hold the PET tape to the coil 232. The PET tape is optional.

The coil 232 is electrically and mechanically attached to the wire 221. In some embodiments, the coil has a resistance of 1.206 ohms and an inductance of 27.27 micro-Henry at a frequency 100 kHz. The operating voltage could be 1 volt at an rms current rating of 2 amps, with a 10.95 coupling distance. This may produce a 14.23 Q parameter.

FIG. 2E shows the details of the bobbin 231. The bobbin 231 has two walls 242 on either side of the coil area 241. In some embodiments, the internal diameter of the bobbin 231 is 22.00 mm and the width is 5.6 mm. The inner width is 4.00 mm in the coil area 241, where the EMI material 233 and the coils 232 are located. In some embodiments, one of the walls 242 has a gap 235 to allow the wire 221 to leave the coil area 241. In some embodiments, the walls 242 are 0.80 mm thick and 0.30 mm high. The gap 235 could be 2 mm wide and 0.30 mm deep.

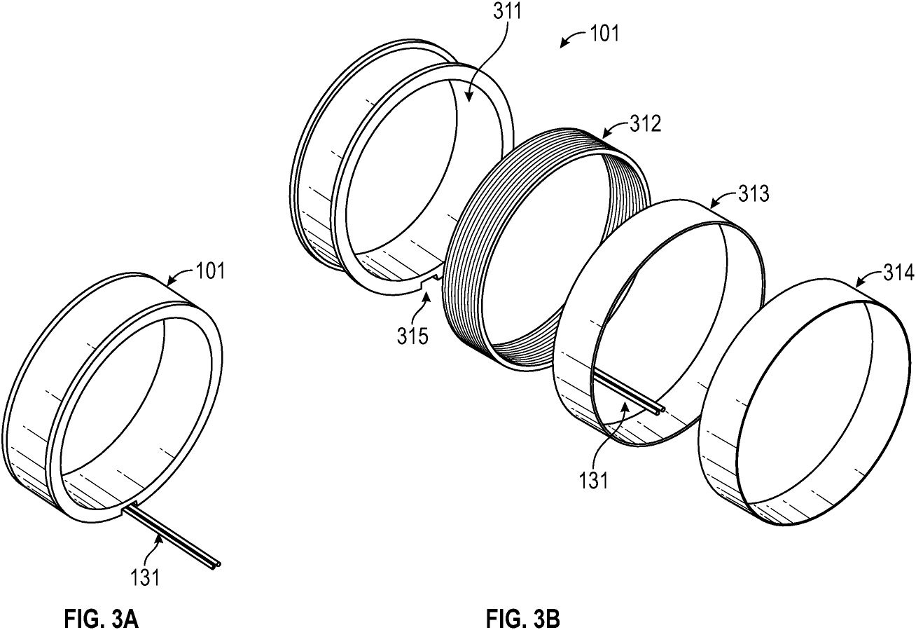

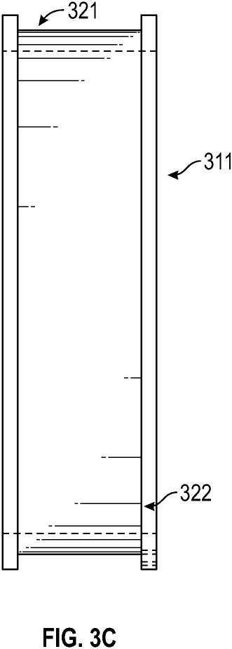

FIG. 3A shows a perspective view of the assembled power transmitting apparatus 101, including a 30 mm wire 131 to bring the power to transmit to the power receiving apparatus 122 in the golf ball 110. Note that the length of the wire 131 can be changed without deviating from the inventions disclosed herein.

FIG. 3B shows an exploded view of the power transmitting apparatus 101. The power transmitting apparatus 101 starts with a bobbin 311 surrounded by the coil 312, EMI material 313, and PET tape 314.

The bobbin 311 could be made of ABS, other plastic, cardboard, wood, or other materials. In some embodiments, the bobbin 311 is injection molded, in other embodiments the bobbin 311 is milled to shape, and in still other embodiments, the bobbin 311 is 3D printed, or any combination thereof.

The coil 312 is wrapped around the bobbin 311. The coil 312 could be made of copper wire, aluminum wire, carbon fiber wire, etc, with an insulation, such as varnish surrounding the wire. Any type of winding technique could be used, such as wild winding, helical winding, orthocyclic winding, etc. In one embodiment, #20 Litz Cable 312 is wrapped 12 times around the bobbin 311 in a single layer. Ths #20 Litz Cable 312 may have a 1 mm diameter.

The coil 312 is covered (encircled) with an EMI material 313 such as copper and aluminum foils, metalized fabrics, conductive elastomers, conductive foams, metals, nickels, carbons, ceramics, cement, conductive polymers, and tapes/transfer adhesives. In some embodiments, the EMI material 313 is a ferrite core. The ferrite core 313 could be made up of a 0.30 mm thick strip of rubber (or silicon rubber), ferrite powder, and PET film, perhaps 12.00 mm wide and 180 mm long that is wrapped around the coil 312 with an overlap of about 12.55 mm. The ferrite core 313 could be held to the coil 312 with an adhesive.

The EMI material 313 could be covered with a PET (polyethylene terephthalate) tape 314. The PET Tape 314 could be made with polyester and could have an acrylic, silicone, and rubber adhesive to hold the PET tape to the coil 232.

The coil 312 is electrically and mechanically attached to the wire 131. In some embodiments, the coil has a resistance of 0.043 ohms and an inductance of 5.80 micro Henry at a frequency 100 kHz. The operating voltage could be 5 volts at an rms current rating of 2 amps, with a 10.95 coupling distance. This may produce an 84.71 Q parameter.

FIG. 3C shows the details of the bobbin 311. The bobbin 311 has two walls 322 on either side of the coil area 321. In some embodiments, the internal diameter of the bobbin 311 is 47.30 mm and the width is 15.00 mm. The external diameter of the bobbin 311 could be 51.30 mm in the coil area and 54 mm at the top of the walls. The inner width is 12.00 mm in the coil area 321, where the EMI material 313 and the coils 312 are located. In some embodiments, one of the walls 322 has a gap 315 to allow the wire 131 to leave the coil area 321. In some embodiments, the walls 322 are 1.60 mm high and 1.50 mm wide. The gap 315 could be 4.4 mm wide and 1.60 mm deep.

The foregoing devices and operations, including their implementation, will be familiar to, and understood by, those having ordinary skill in the art. All sizes used in this description could be scaled up or down without impacting the scope of these inventions. All dimensions in the figures or description are used to show one possible embodiment. Other dimensions may be used without deviating from the inventions herein.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

1. A system for charging an electronic golf ball and the electronic golf ball, the system comprising:
a charging apparatus comprising:
a holder for holding the electronic golf ball;
a power transmitting apparatus mounted within the holder, the power transmitting apparatus encircling an area where the electronic golf ball is located when the electronic golf ball is to be charged; and
a power supply electrically connected to the power transmitting apparatus; and
the electronic golf ball comprising:
an outer shell;
a ball core covered by the outer shell;
a power receiving apparatus within the ball core, wherein the power receiving apparatus receives power wirelessly from the power transmitting apparatus;
a printed circuit board including a microprocessor chip and a power conditioning chip electrically connected to the power receiving apparatus; and
a battery electrically connected to the power conditioning chip on the printed circuit board, wherein electricity passes from the power conditioning chip to the battery when the power conditioning chip receives a Boolean input.

2. The system of claim 1 wherein the printed circuit board includes a Qi chip.

3. The system of claim 1 wherein the power transmitting apparatus has wires wound around the power transmitting apparatus to form a coil.

4. The system of claim 3 wherein the coil is surrounded by EMI material.

5. The system of claim 4 wherein the EMI material is a ferrite core.

6. The system of claim 1 wherein the power receiving apparatus has wires wound around the power receiving apparatus to form a coil.

7. The system of claim 6 wherein EMI material encircles the power receiving apparatus underneath the coil.

8. The system of claim 7 wherein the EMI material is a ferrite core.

9. A method for charging an electronic golf ball comprising:
receiving power from a power supply;
delivering the power over a wire to a power transmitting apparatus;
wirelessly transmitting the power from the power transmitting apparatus through a golf ball outer shell and a golf ball core;
receiving the wirelessly transmitted power with a power receiving apparatus located within the golf ball core;
delivering the power from the power receiving apparatus to a power conditioning chip on a printed circuit board located in the electronic golf ball, wherein the printed circuit board comprises the power conditioning chip and a microprocessor;
using the power from the power conditioning chip to recharge a battery located in the electronic golf ball when the power conditioning chip receives an input to start charging; and
power the printed circuit board with the battery.

10. The method of claim 9 wherein the power conditioning chip is a Qi chip.

11. The method of claim 9 wherein the power conditioning chip also directly provides the power to the microprocessor.

12. The method of claim 9 wherein the power transmitting apparatus has wires wound around the power transmitting apparatus to form a coil.

13. The method of claim 12 wherein the coil is surrounded by EMI material.

14. The method of claim 13 wherein the EMI material is a ferrite core.

15. The method of claim 9 wherein the power receiving apparatus has wires wound around the power transmitting apparatus to form a coil.

16. The method of claim 15 wherein EMI material encircles the power receiving apparatus underneath the coil.

17. The method of claim 16 wherein the coil is a ferrite core.

18. An electronic golf ball apparatus comprising:
an outer shell;
a ball core covered by the outer shell;
a power receiving apparatus within the ball core, wherein the power receiving apparatus receives power wirelessly;
a printed circuit board including a microprocessor chip and a power conditioning chip electrically connected to the power receiving apparatus; and
a battery electrically connected to the power conditioning chip on the printed circuit board, wherein electricity passes from the power conditioning chip to the battery when the power conditioning chip receives a Boolean input.

19. The electronic golf ball apparatus of claim 18 wherein the power receiving apparatus includes wires wound around the power receiving apparatus to form a coil.

20. The electronic golf ball apparatus of claim 19 wherein EMI material encircles the power receiving apparatus underneath the coil.
